(19) United States
(12) Patent Application Publication
(10) Pub. No.: US 2003/0039352 A1
(43) Pub. Date: Feb. 27, 2003

(54) Receiver, method, program and carrier signal for adapting the sound volume of an acoustic signal of an incoming call

(76) Inventors: Yann Andre Roland Joncour, Le Mans (FR); Laurent Lucat, Le Mans (FR)

Correspondence Address: U.S. Philips Corporation, 580 White Plains Road, Tarrytown, NY, 10591, US

(21) Appl. No.: 10/195,457

(22) Filed: Jul. 15, 2002

(30) Foreign Application Priority Data
Jul. 17, 2001 (FR) 0109549

(51) Int. Cl. H04M 1/00; H04M 3/00

(52) U.S. Cl. 379/390.01; 379/375.01

(57) ABSTRACT

The invention relates to a communication receiver provided with a loudspeaker and/or a microphone and means for automatically adapting the volume of the loudspeaker and/or microphone according to the local acoustic environment of the receiver and in particular the degree of confinement of the environment. Confinement detection means are provided and comprise adaptive filtering means for modeling the acoustic channel of the receiver by means of the pulse response of an adaptive filter and calculation and comparison means for calculating a power ratio between a partial power and the total power of said pulse response to compare it with reference values and to derive therefrom an estimation of said degree of confinement. Application: Mobile telephony.

The invention relates to a telephone receiver comprising emission means for emitting an audible signal with a variable sound level and means of adjusting said sound level. The invention also relates to a method of adjusting said sound level. It also relates to a computer program for implementing this method. The invention has many applications particularly in radiotelephone receivers.

International patent application published under the number WO9905850 describes a method for automatic sound level control for controlling the sound level of a telephone ring according to the characteristics of the local environment of the telephone. The document makes assumptions on the ringing signal and provides means for modifying the characteristics of this signal according to the local environment.

One object of the invention is to provide means for adjusting the sound level of the signal emitted by a telephone receiver enabling a user to hear this signal when the receiver is situated in a confined space, for example inside a bag, by defining a degree of confinement of the local environment of the receiver.

For this purpose, a receiver is provided of the type mentioned in the introductory paragraph, having confinement detection means for detecting a degree of confinement of the local environment of the receiver and means of controlling said adjustment means for controlling the adjustment of said sound level according to the result of the detection.

According to an important characteristic of the invention, the confinement detection means comprise adaptive filtering means for modeling the acoustic channel of the receiver by means of the pulse response of an adaptive filter and calculation and comparison means for calculating a power ratio between a partial power and the total power of said pulse response to compare it with reference values and to derive therefrom an estimation of said degree of confinement.

The invention will be further described with reference to examples of embodiment shown in the drawings to which, however, the invention is not restricted.

FIG. 1 is a diagram depicting a receiver according to the invention situated in a confined local environment,

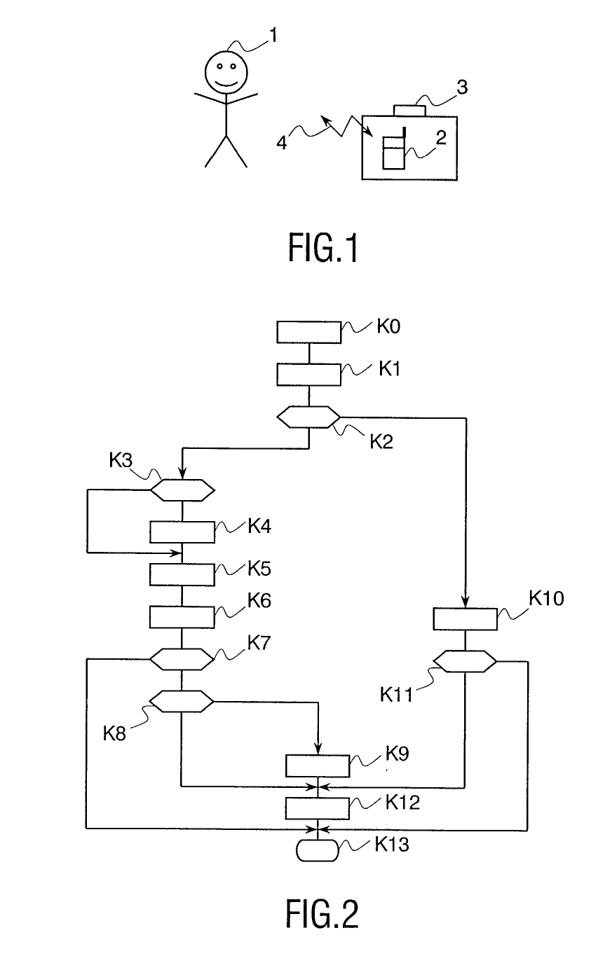

FIG. 2 is a flow chart for illustrating an example of the method according to the invention,

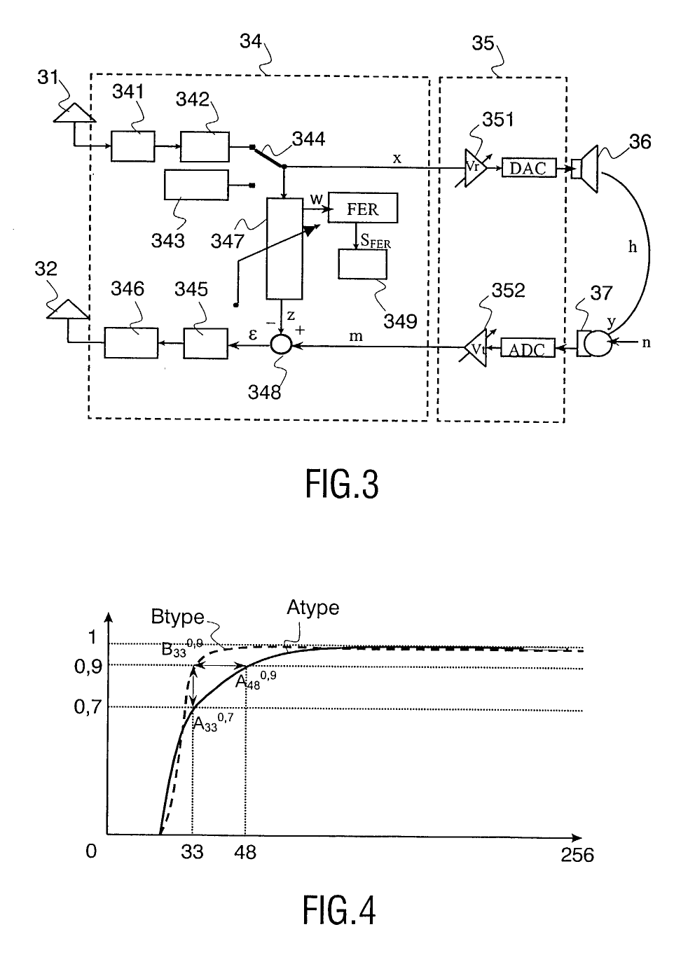

FIG. 3 is a functional block diagram showing an example of embodiment of a receiver according to the invention,

FIG. 4 is a diagram depicting experimental test results.

FIG. 1 depicts a user 1 and a telephone receiver 2 which is situated in a confined environment represented by a bag 3. When the user receives a call, referred to as the incoming call, the receiver indicates this incoming call to him by emitting an audible signal 4 by means of a loudspeaker. This signal can be any type of audible signal such as a ring, a voice message, music etc. In the situation illustrated by FIG. 1, the telephone receiver is located in a more or less closed limited space where the sound does not propagate well to the outside and inside. According to the invention, this type of environment is referred to as a confined environment.

Two major problems may be posed when the receiver is located in a confined environment. A first problem is posed at the time of emission of the audible call signal indicating an incoming call. This is because there is a risk that the user may not hear the sound signal emitted by the receiver and miss an incoming call since the sound does not propagate well to the outside. A second problem is posed at the time of picking up the call, when the receiver is equipped with a voice control device enabling the user to off-hook his telephone and begin a communication by means of prerecorded voice commands without taking his receiver in his hand and therefore without taking it from its original local environment. The voice control device comprises a microphone situated in the receiver for picking up the voice control signal. In a confined environment such as the one illustrated in FIG. 1, where the sounds do not propagate well from the outside to the inside, there is a risk that the microphone may not capture the voice control signal from the user and therefore not trigger the off-hook of the call.

FIG. 2 illustrates a method according to the invention for enabling a user to receive and off-hook a call on his telephone receiver when the latter is situated in a confined environment, for example in a bag, drawer, deep or closed pocket, etc. The method includes the following steps:

a call reception step K0 for receiving an incoming call,

a call notification step K1 with in parallel an evaluation of the local acoustic environment of the receiver,

a confinement detection step K2 for detecting the degree of confinement of the local environment,

if the result of the detection step K2 indicates that the local environment is confined, the method continues with a step K3 for checking whether the voice control off-hook mode is activated.

If the voice control off-hook mode is activated, the method continues with step K4 to increase the emission volume, and then with step K5 to increase the reception volume, otherwise the method passes directly to step K5.

Step K6 indicates that the receiver continues to emit an audible call signal with the changes in volume.

At the following step K7, a test is carried out to determine whether the call is accepted or rejected by the user:

if the call is rejected, the method terminates at step K13,

otherwise it continues with step K8 to reiterate a test on the degree of confinement of the local environment since the user could have removed the receiver from the local environment in which it was at the start of the method.

If the local environment is confined, the method continues directly with step K12 to continue the communication, and then K13 to end it,

Otherwise it passes through step K9, to automatically reinitialize the sound volumes at levels predetermined by the user and corresponding to a normal use when the user and receiver are situated in the same local environment, and then continues with steps K12 and K13.

If the result of the detection step K2 indicates that the local environment is not confined, the method continues at step K10 to continue to emit the sound signal with the reference sound level parameters prerecorded by the manufacturer or by the user.

The following step K11 is identical with step K7, except that, if the call is accepted, it is not necessary in general to carry out a confinement test again, and the method then passes to step K12 and then terminates at step K13.

FIG. 3 is an example of embodiment of a receiver according to the invention. It comprises a receiving antenna 31, a transmitting antenna 32, a digital signal processing unit 34, for example used by means of a processor of the DSP type (Digital Signal Processor), an audio encoding/decoding unit 35, a loudspeaker 36 and a microphone 37. The audio encoding/decoding unit 35 performs the analog to digital conversions ADC and digital to analog conversions DAC as well as the quantization of the signal thus digitized. The digital signal processing unit 34 comprises, for reception: a channel decoding unit 341, a source decoding unit 342, a melody generating unit 343, a switch 344 and, for transmission: a source coding unit 345 and a channel coding unit 346.

When the receiver receives a call, the receiving antenna 32 receives an incoming call notification signal which must successively be decoded by the channel decoder 341 and the source decoder 342. If the call signal mode chosen is of the melody type, the switch 344 can switch to be connected to the melody generator 343 with a view to generating a prerecorded melody by way of an audible signal indicating to the user an incoming call. The incoming call notification signal, referred to as the received signal and denoted x, is then transmitted to the audio encoding/decoding unit 35 to be decoded and then transmitted to the loudspeaker 36. The received signal x is transformed by an amplifier 351 into a signal with a sound volume predetermined by the user or manufacturer, before being converted into an analog signal by the digital to analog converter DAC, and then emitted by the loudspeaker 36 in the form of a sound signal, denoted h. A filtered version, denoted y, of the signal h emitted by the loudspeaker is picked up by the microphone 35 because of the acoustic coupling existing between the loudspeaker and the microphone, generally situated at a short distance from each other in a small receiver. The signal h emitted by the loudspeaker represents the pulse response of the acoustic coupling between the loudspeaker and the microphone. This pulse response h can be determined by an acoustic echo canceller used in the signal processing unit DSP, for example by an adaptive filter 347, a subtractor 348, a calculation unit FER and a volume control unit 349.

The microphone 37 also captures an additional signal, referred to as the useful signal, corresponding to the voice of the user called, present in particular when the “voice control” mode is activated, possibly with noise added. This additional signal is denoted n. The signal transmitted by the microphone 37 to the digital processing unit DSP is denoted m. It corresponds to the sum of the signals y and n. The signal m, converted by the analog to digital converter ADC, is amplified by an amplifier 352 according to a volume level determined by the volume control unit 349. The signal m transmitted to the signal processing unit DSP represents the acoustic echo introduced by the acoustic coupling between the loudspeaker and the microphone. The echo canceller eliminates this echo.

The detection of the degree of confinement corresponding to steps K2 and K8 of the method according to the invention described in FIG. 2 can advantageously be implemented for example by means of the echo canceller present in the digital signal processing unit DSP. According to one advantageous embodiment described below, the characteristics of the local acoustic environment of the receiver which are determined by the echo canceller are used to effect the confinement detection. This is because the acoustic coupling between the loudspeaker 36 and the microphone 37 depends on the location of the receiver, that is to say its local acoustic environment. For example, the pulse response of the acoustic channel is longer in an open local environment consisting of a large room in which the receiver is simply placed on a table than in a closed local environment consisting of a purse in which the receiver is enclosed. The type of local acoustic environment, confined/open, and the degree of confinement of the local environment, can be determined by an estimation of the acoustic coupling effected in the receiver.

According to the invention, this estimation is carried out by means of the adaptive filter 347 used in the echo canceller to model the acoustic channel of the receiver. The adaptive filter 347 receives as an input the received signal x, corresponding to the incoming call notification. It delivers as an output a signal, denoted z, which is subtracted from the echo signal m transmitted by the microphone 37 to obtain an error signal ε. The coefficients of the adaptive filter 347 are adapted from the error signal ε, according to a recursive algorithm such as the normalized least squares algorithm, also referred to as NLMS (Normalized Least Mean Square), described in the document by S. Haykin, “Adaptive Filter Theory. Third Edition,” published by Prentice Hall, 1996. This algorithm makes it possible to update the coefficients of the adaptive filter to minimize the error ε. After adaptation of the coefficients of the filter, the pulse response of the filter, denoted w, which represents a modeling of the acoustic channel, has converged towards the pulse response of the acoustic coupling h between the loudspeaker and the microphone. This makes it possible to determine the acoustic coupling existing between the loudspeaker and the microphone and thus to characterize the local acoustic environment of the receiver. When the coefficients of the filters are adapted, the error ε is canceled, the value of z is practically equal to m and w=h.

According to a preferred embodiment of the invention, the pulse response of the acoustic coupling h between the loudspeaker and the microphone is characterized by means of an energy ratio between part of the energy of the pulse response w of the adaptive filter 347 and the total energy of the pulse response w of the filter. This ratio, denoted FER(k), can, for example, be defined by the following equation (1):

$$FER ( k ) = \frac{{\sum }_{i = 0}^{k} {w}^{2} ( i )}{{\sum }_{i = 0}^{L - 1} {w}^{2} ( i )} \qquad ( 1 )$$

where k and i are indices corresponding to the coefficients of the adaptive filter 341 and L is the length of the pulse response of the filter. The ratio FER (k) represents the ratio between the energy of a segment of the pulse response of the adaptive filter between the coefficients 1 and k of the filter and the total energy of the pulse response of the filter. The type of local environment can then be determined by calculating the energy ratio FER(k₀) for a predetermined filter coefficient index, denoted k₀, and by comparing this ratio with reference values. The more confined the local environment, the closer the energy ratio FER(k₀) is to 1. These energy calculations are performed by the calculation unit FER. It receives as an input the pulse response w of the adaptive filter 347 and delivers as an output a control signal S_{FER}. The control signal S_{FER} represents the energy ratio FER(k₀). It is intended to control the volume control unit 349. The calculated energy ratio FER(k₀) determines the result of the detection of the degree of confinement of the local environment of the receiver according to steps K2 and K8 described in FIG. 2. The volume control signal S_{FER} controlled by the calculation unit FER indicates to the volume control unit 349 that it should increase or reduce the sound volume of the signals emitted by the loudspeaker 36 and/or picked up by the microphone 37, according to the procedure described at steps K4 and K5 of FIG. 2.

FIG. 4 shows results of experimental tests carried out in two different acoustic environments. The tests were performed with a mobile radiotelephone receiver of the type described in FIG. 3 provided with an adaptive 256-coefficient filter. The receiver was previously configured so as to emit an audible incoming call signal in the form of a melody synthesized by frequency modulation. FIG. 4 shows two curves illustrating the energy ratio FER(k) defined in equation (1) according to an index k representing the number of samples used in the numerator of equation (1).

The bold curve represents the energy ratio FER(k) observed in a local environment, said to be of type A, open or unconfined, consisting of a large room furnished with a table on which the receiver is placed. The curve in a dotted line represents the energy ratio FER(k) observed in a confined local environment, said to be of type B, consisting of a bag in which the receiver is enclosed.

On each curve, two points are indicated by a horizontal double arrow and a vertical double arrow. The horizontal double arrow indicates a point on each curve, denoted B₃₃^{0.9} and A₄₈^{0.9}, which represent an identical energy ratio FER equal to 0.9 for the two points, for an index k₀=33 (type B curve) and 48 (type A curve) respectively. The vertical double arrow indicates a point on each curve, that is to say point B₃₃^{0.9} and a point A₃₃^{0.7}, representing energy ratios of 0.9 (type B curve) and 0.7 (type A curve) respectively for the same index k₀=33. The points indicated by the two double arrows represent the acoustic coupling difference between the type A and B environments. The horizontal double arrow shows that 33 or 48 filter coefficients concentrate 90% of the total energy of the pulse response of the adaptive filter, depending on whether the local environment of the receiver is type B or A respectively. The vertical double arrow shows that the first 33 coefficients of the filter concentrate 70% or 90% of the total energy of the pulse response of the adaptive filter depending on whether the local environment of the receiver is type A or B respectively. At least two embodiments of the degree of confinement detector according to the invention can be derived from this graph.

According to a first embodiment, the detection of the degree of confinement is effected in a calculation unit FER by comparing the value of the index k, for an energy ratio FER(k) of 0.9, with reference values lying, for example, between 33 and 48 and corresponding to acoustic environments with decreasing degrees of confinement, ranging from type B to type A.

According to a second embodiment, the detection of the degree of confinement is effected in a calculation unit FER by calculating the energy ratio FER(k) for a given index, for example k₀=33, and comparing it with reference values lying, for example, between 0.7 and 0.9 and corresponding to acoustic environments with increasing degrees of confinement ranging from type A to type B.

The signal S_{FER} transmitted to the volume control unit 349 contains information on the degree of confinement calculated by the calculation unit FER. This information, denoted FER(k₀), as well as other information such as volume information specified by the manufacturer, denoted V_{DET}, and information predefined by the user, denoted V_{USERr}, are used by the control unit 343 to adjust the volume levels Vᵣ and Vₜ of the amplifiers 351 and 352 respectively, in accordance with the following equations:

Vᵣ=max(V_{USER}+f(FER(k₀),Vₘₐₓ⁽¹⁾) (2)

Vₜ=max(V_{DET}+g(FER(k₀),Vₘₐₓ⁽²⁾) (3)

where f and g can in particular be discrete functions and where Vₘₐₓ⁽¹⁾ and Vₘₐₓ⁽²⁾ are predefined maximum values. By way of an example embodiment, the function f can have the following simple form:

$$f ( FER ( {k}_{0} ) ) = \{ \begin{matrix}0 for FER ( {k}_{0} ) < 0.9 \\ 1 for FER ( {k}_{0} ) \geq 0.9\end{matrix} \} \qquad ( 4 )$$

A receiver, a method, a computer program and a signal for automatically adapting the volume of the loudspeaker and microphone in a communication receiver, according to the local acoustic environment of the receiver and in particular its degree of confinement, have thus been described and illustrated by means of examples. Other example embodiments can easily be derived from the embodiments described without departing from the scope of the invention. In particular, the invention is not limited to the type of signal processed: off-hook by voice recognition, incoming call notification etc, nor the nature of the signal, melody, voice etc.

1. A telephone receiver comprising emission means (36) for emitting a sound signal with a variable sound level and means (351) of adjusting said sound level, characterized in that it comprises confinement detection means (347; FER) for detecting a degree of confinement of the local environment of the receiver and means (349) of controlling said adjustment means for controlling the adjustment of said sound level according to the result of the detection.

2. A receiver as claimed in claim 1, in which said confinement detection means (347; FER) comprise adaptive filtering means (347) for modeling the acoustic channel of the receiver using the pulse response (w) of an adaptive filter and calculation and comparison means (FER) for calculating a power ratio (FER(k)) between a partial power and the total power of said pulse response to compare it with reference values and to derive therefrom an estimation of said degree of confinement.

3. A method of adjusting the sound level of a signal emitted by a telephone receiver, characterized in that it comprises a confinement detection step (K2; K8) for detecting a degree of confinement of the local environment of the receiver and an adjustment step (K4; K5) for adjusting said sound level according to the result of the detection.

4. A method as claimed in claim 3, in which the confinement detection step comprises an adaptive filtering step for modeling the acoustic channel of the receiver by means of the pulse response of an adaptive filter and a calculation and comparison step for calculating a power ratio between a partial power and the total power of said pulse response to compare it with reference values and to derive therefrom an estimation of said degree of confinement.

5. A computer program containing program code instructions for implementing the method as claimed in claim 4.

6. A signal for carrying a computer program as claimed in claim 5.
